(19) United States
(12) Patent Application Publication
(10) Pub. No.: US 2011/0257778 A1
(43) Pub. Date: Oct. 20, 2011

(54) METHOD AND DEVICE FOR SIMULATING NC WORKING MACHINE

(75) Inventors: Nobuyuki Takahashi, Tokyo (JP); Kenji Iriguchi, Tokyo (JP); Takashi Kamiya, Tokyo (JP); Takashi Yoneda, Tokyo (JP); Mahito Matsuura, Tokyo (JP)

(73) Assignee: MITSUBISHI ELECTRIC CORPORATION, Tokyo (JP)

(21) Appl. No.: 13/141,735

(22) PCT Filed: Dec. 24, 2008
(86) PCT No.: PCT/JP2008/003920

§ 371 Date: Jun. 23, 2011

(51) Int. Cl. G05B 19/4069

(52) U.S. Cl. 700/104

(57) ABSTRACT

Even in an uncuttable state in which an actual rotational direction of a main spindle is not matched with an actually cuttable main spindle rotational direction of a tool, an interference check between a workpiece and the tool is performed. Accordingly, the cuttable main spindle rotational direction of the selected tool or the uncuttable main spindle rotational direction is compared with each main spindle rotational direction of a working machine during execution of a simulation, and it is determined whether an interference check between the tool blade edge and the workpiece is necessary on the basis of the comparison result. When it is determined that the interference check is not necessary in the step above, the interference check between the tool blade edge and the workpiece is not performed. When it is determined that the interference check is necessary, the interference check between the tool blade edge and the workpiece is performed. When the interference therebetween is present, abnormality is detected.

### TECHNICAL FIELD

The present invention relates to a method and a device for simulating an NC working machine that is controlled by a numerical control (hereinafter, referred to as “NC”) device, and particularly, to an improvement in accuracy of an interference check.

### BACKGROUND ART

Recently, since the number of shafts and systems of an NC working machine has been increasing, the operation thereof has been becoming difficult. Therefore, an NC machine has a function of preventing collisions (refer to Patent Document 1).

Since the NC working machine is originally used to cut a workpiece in a desired shape while a tool contacts the workpiece, generally the combination of the tool and the workpiece is not included in the interference check target in the collision preventing function of the NC working machine and the simulation of the NC working machine.

However, in an actual circumstance of the NC working machine using a rotation tool such as a drill, the contact between the workpiece and the tool needs to be prevented in the following cases of (1) to (3). Therefore, there is a proposal in which an interference check between the tool and the workpiece is performed (refer to Patent Document 2).

(1) Case where the rotation of a main spindle is stopped (rotation of a rotation tool is stopped),

(2) Case where a cutting feed speed as a relative feed speed of a tool with respect to a workpiece becomes faster than a maximum cutting feed speed set in accordance with a material of the workpiece, and

(3) Case where a drill (or a tap) is moved in the X-axis and Y-axis direction perpendicular to the Z-axis direction as a cuttable axis direction of the drill (or the tap) so that the drill (or the tap) is positioned to a perforating position.
[Patent Document 1] JP-A-2004-227047
[Patent Document 2] JP-A-2008-27045

### DISCLOSURE OF INVENTION

### Problem that the Invention is to Solve

As described above, in the collision preventing function of the NC working machine and the simulation of the NC working machine, interference or processing abnormality due to the moving of the feed shaft of the NC working machine is checked.

However, in the case of the background art, since the rotational direction of the main spindle during processing is not matched with the main spindle rotational direction in which the tool may actually perform the cutting, abnormality such as damage of the tool or the workpiece may not be detected.

For example, as shown in FIG. 13, in many cases, a turning bite has a blade on only one surface of the bite, and only the surface having the blade may be used to perform the cutting. In the case of this kind of tool, when the cutting surface of the tool is not disposed to face the rotational direction about the turning main spindle, the cutting may not be normally performed (when the cutting surface of the tool faces the left direction of the drawing as shown in FIG. 13 and the main spindle rotates in the counter-clockwise direction as shown in FIG. 13, the workpiece may not be normally cut). In particular, in a multi-functional machine having both a turning function and a milling function, a turning tool may be attached to a main spindle of a mill. Further, a workpiece set in a second turning main spindle may be processed by rotating the turning tool about the main spindle of the mill by a predetermined angle, for example, 180 degree of angle in the case of the facing main spindles. This kind of NC working machine needs to be especially carefully operated.

On the other hand, in the case of the rotation tool shown in FIG. 14, in many cases, the tool normally rotates about the main spindle, but there is, for example, a reverse tap tool that requires a reverse rotation about the main spindle. Accordingly, even in the rotation tool, the feed axis direction where the cutting may be performed by the tool is not matched with the rotational direction of the main spindle during processing, the processing may not be normally performed.

Accordingly, if through only the determination whether the feed axis direction is correct or if the main spindle rotates (whether it is an ON state or an OFF state), it is not possible to detect an abnormal state in which the tool contacts the workpiece in an uncuttable state, so that the tool or the workpiece is damaged.

The invention is made to solve the above-described problems of the background art, and provides a method and a device for simulating an NC working machine capable of performing an interference check between a workpiece and a tool even when the cutting may not be performed such that the rotational direction of the main spindle of the machine during processing is not matched with the main spindle rotational direction where the tool may actually perform the cutting.

### Means for Solving the Problem

The invention is made to solve the above-described problems, and provides a method for simulating an NC working machine so that a processing shape of a workpiece or a movement of a machine is simulated by using a shape of the tool or the workpiece, the method including the steps of: deciding a cuttable main spindle rotational direction or an uncuttable main spindle rotational direction for each tool in advance before execution of a simulation; comparing the cuttable main spindle rotational direction or the uncuttable main spindle rotational direction of the selected tool with each main spindle rotational direction of a working machine during the execution of the simulation so as to determine whether an interference check between the tool and the workpiece is necessary on the basis of the comparison result; and disabling the interference check between the tool and the workpiece when it is determined that the interference check is not necessary in the step above, enabling the interference check between the tool and the workpiece when it is determined that the interference check is necessary, and detecting abnormality when the interference between the tool and the workpiece is present.

Further, there is provided a method for simulating an NC working machine so that a processing shape of a workpiece or a movement of a machine is simulated by using a shape of the tool or the workpiece, the method including the steps of: deciding a cuttable main spindle rotational direction and a cuttable feed axis direction or an uncuttable main spindle rotational direction and an uncuttable feed axis direction for each tool in advance before execution of a simulation; comparing the cuttable main spindle rotational direction or the uncuttable main spindle rotational direction of the selected tool with each main spindle rotational direction of a working machine during the execution of the simulation so as to determine whether an interference check between the tool and the workpiece is necessary; comparing the cuttable feed axis direction or the uncuttable feed axis direction of the selected tool with each feed axis direction of a working machine during the execution of the simulation so as to determine whether an interference check between the tool and the workpiece is necessary on the basis of the comparison result; and disabling the interference check between the tool and the workpiece when it is determined that the interference check is not necessary in the step above, enabling the interference check between the tool and the workpiece when it is determined that the interference check is necessary, and detecting abnormality when the interference between the tool and the workpiece is present.

Further, in the method, the cuttable main spindle rotational direction and the cuttable feed axis direction or the uncuttable main spindle rotational direction and the uncuttable feed axis direction are decided on the basis of wedge clamp data of the tool set in advance in tool data.

Further, in the method, the cuttable main spindle rotational direction or the uncuttable main spindle rotational direction is expressed as a vector of the cuttable main spindle rotational direction or a vector of the uncuttable main spindle rotational direction given to tool shape data related to data of each tool stored in the tool data.

Further, in the method, the cuttable main spindle rotational direction and the cuttable feed axis direction or the uncuttable main spindle rotational direction and the uncuttable feed axis direction are expressed as a vector of the cuttable main spindle rotational direction and a vector of the cuttable feed axis direction or a vector of the uncuttable main spindle rotational direction and a vector of the uncuttable feed axis direction given to tool shape data related to data of each tool stored in the tool data.

Further, in the method, the cuttable main spindle rotational direction and the cuttable feed axis direction or the uncuttable main spindle rotational direction and the uncuttable feed axis direction of the tool data are expressed as vectors given to tool shape data, and in the case of a tool allowing a deviation between the vectors within a certain range, an allowable angle is given to the vectors.

Further, there is provided a device for simulating an NC working machine so that a processing shape of a workpiece or a movement of a machine is simulated by using a shape of the tool or the workpiece, the device including: a storage unit which stores a cuttable main spindle rotational direction or an uncuttable main spindle rotational direction for each tool; an interference check condition determination/update unit which compares the cuttable main spindle rotational direction or the uncuttable main spindle rotational direction of the selected tool with each main spindle rotational direction of a working machine during the execution of the simulation so as to determine whether an interference check between the tool and the workpiece is necessary on the basis of the comparison result; and a working machine simulation unit which disables the interference check between the tool and the workpiece when the interference check condition determination/update unit determines that the interference check is not necessary, enables the interference check between the tool and the workpiece when the interference check condition determination/update unit determines that the interference check is necessary, and detects abnormality when the interference between the tool and the workpiece is present.

Further, there is provided a device for simulating an NC working machine so that a processing shape of a workpiece or a movement of a machine is simulated by using a shape of the tool or the workpiece, the device including: a storage unit which stores a cuttable main spindle rotational direction and a cuttable feed axis direction or an uncuttable main spindle rotational direction and an uncuttable feed axis direction for each tool; an interference check condition determination/update unit which compares the cuttable main spindle rotational direction or the uncuttable main spindle rotational direction of the selected tool with each main spindle rotational direction of a working machine, and compares the cuttable feed axis direction or the uncuttable feed axis direction of the selected tool with each feed axis direction of a working machine during the execution of the simulation so as to determine whether an interference check between the tool and the workpiece is necessary on the basis of the comparison result; and a working machine simulation unit which disables the interference check between the tool and the workpiece when the interference check condition determination/update unit determines that the interference check is not necessary, enables the interference check between the tool and the workpiece when the interference check condition determination/update unit determines that the interference check is necessary, and detects abnormality when the interference between the tool and the workpiece is present.

Further, there is provided a device for simulating an NC working machine so that a processing shape of a workpiece or a movement of a machine is simulated by using a shape of the tool or the workpiece, the device including: a storage unit which stores wedge clamp data of the tool for each tool; an interference check condition determination/update unit which decides a cuttable main spindle rotational direction or an uncuttable main spindle rotational direction and a cuttable feed axis direction or an uncuttable feed axis direction on the basis of the wedge clamp data of the tool, compares the cuttable main spindle rotational direction or the uncuttable main spindle rotational direction of the selected tool with each main spindle rotational direction of a working machine, and compares the cuttable feed axis direction or the uncuttable feed axis direction of the selected tool with each feed axis direction of a working machine during the execution of the simulation so as to determine whether an interference check between the tool and the workpiece is necessary on the basis of the comparison result; and a working machine simulation unit which disables the interference check between the tool and the workpiece when the interference check condition determination/update unit determines that the interference check is not necessary, enables the interference check between the tool and the workpiece when the interference check condition determination/update unit determines that the interference check is necessary, and detects abnormality when the interference between the tool and the workpiece is present.

Further, in the device, the cuttable main spindle rotational direction or the uncuttable main spindle rotational direction is expressed as a vector of the cuttable main spindle rotational direction or a vector of the uncuttable main spindle rotational direction given to tool shape data related to data of each tool stored in the tool data.

Further, in the device, the cuttable main spindle rotational direction and the cuttable feed axis direction or the uncuttable main spindle rotational direction and the uncuttable feed axis direction are expressed as a vector of the cuttable main spindle rotational direction and a vector of the cuttable feed axis direction or a vector of the uncuttable main spindle rotational direction and a vector of the uncuttable feed axis direction given to tool shape data related to data of each tool stored in the tool data.

Further, in the device, the cuttable main spindle rotational direction and the cuttable feed axis direction or the uncuttable main spindle rotational direction and the uncuttable feed axis direction of the tool data are expressed as vectors given to tool shape data, and in the case of a tool allowing a deviation between the vectors within a certain range, an allowable angle is given to the vectors.

### Advantageous Effects

According to the invention, even in the uncuttable state in which the rotational direction of the main spindle of the machine during processing is not matched with the actually cuttable main spindle rotational direction, the interference check between the workpiece and the tool may be performed. Therefore, the number of paths not including the interference check between the workpiece and the tool is reduced, which has an advantage in that an abnormal state may more reliably detected.

Further, according to the invention, the cuttable main spindle rotational direction and the cuttable feed axis direction or the uncuttable main spindle rotational direction and the uncuttable feed axis direction included in the tool data of the turning bite are decided from the data of the wedge clamp of the tool set in advance in the tool data. Therefore, there is an advantage in that the trouble of setting the tool data for the interference check may be reduced.

Furthermore, according to the invention, the cuttable feed axis direction and the cuttable main spindle rotational direction or the uncuttable feed axis direction and the uncuttable main spindle rotational direction included in the tool data are expressed as the vector included in the shape data of the tool set in advance in the tool data. Then, in the case of the tool including plural components, the final direction of the vector when the tool is finally assembled is compared with the vector of the feed axis direction or the main spindle rotational direction of the imaginary NC working machine, so that the inference check condition is determined and updated. Therefore, there is an advantage in that the necessity of the interference check may be correctly determined at all times.

Moreover, according to the invention, the cuttable main spindle rotational direction and the cuttable feed axis direction or the uncuttable main spindle rotational direction and the uncuttable feed axis direction included in the tool data are expressed as the vector given to the tool shape data. Then, in the case of the tool allowing the deviation between the vectors within a certain range, the allowable angle is given, and the interference check condition is determined and updated using the allowable angle. Therefore, there is an advantage in that the determination and the update of the interference check condition are more practically performed.

### BRIEF DESCRIPTION OF DRAWINGS

FIG. 1 is a block diagram illustrating the main part of a simulation device according to a first embodiment of the invention.

FIG. 2 is a diagram illustrating tool data of the simulation device according to the first embodiment of the invention.

FIG. 3 is a flowchart illustrating an entire operation of the simulation device according to the first embodiment of the invention.

FIG. 4 is a flowchart illustrating an operation of an interference check determination/update unit of the simulation device according to the first embodiment of the invention.

FIG. 5 is a diagram illustrating tool data used for illustrating the operation of the simulation device according to the first embodiment of the invention.

FIG. 6 is a diagram illustrating other tool data used for illustrating the operation of the simulation device according to the first embodiment of the invention.

FIG. 7 is a diagram illustrating an example other than the tool data according to the first embodiment of the invention.

FIG. 8 is a diagram illustrating an example of a tool shape according to a second embodiment of the invention.

FIG. 9 is a flowchart illustrating an operation of an interference check condition determination/update unit of a simulation device according to the second embodiment of the invention.

FIG. 10 is a diagram illustrating a vector used for explaining the operation of the simulation device according to the second embodiment of the invention.

FIG. 11 is a diagram illustrating a turning tool and a tool holder used for explaining the effects of the simulation device according to the second embodiment of the invention.

FIG. 12 is a diagram illustrating a working machine having facing main spindles used for explaining the effect of the simulation device according to the second embodiment of the invention.

FIG. 13 is a diagram illustrating a relationship between a turning tool and a rotational direction of a workpiece used for explaining the problem of the background art.

FIG. 14 is a diagram illustrating a relationship between a rotation/feed axis direction of the rotation tool and a workpiece used for explaining the problem of the background art.

### EXPLANATION OF REFERENCE

1: NC PROGRAM
2: INPUT DEVICE
3: TOOL DATA STORAGE UNIT
4: NC DEVICE EMULATION UNIT
5: INTERFERENCE CHECK CONDITION DETERMINATION/UPDATE UNIT
6: WORKING MACHINE SIMULATION UNIT
7: SHAPE DATA STORAGE UNIT
8: DISPLAY DEVICE

### BEST MODE FOR CARRYING OUT THE INVENTION

### First Embodiment

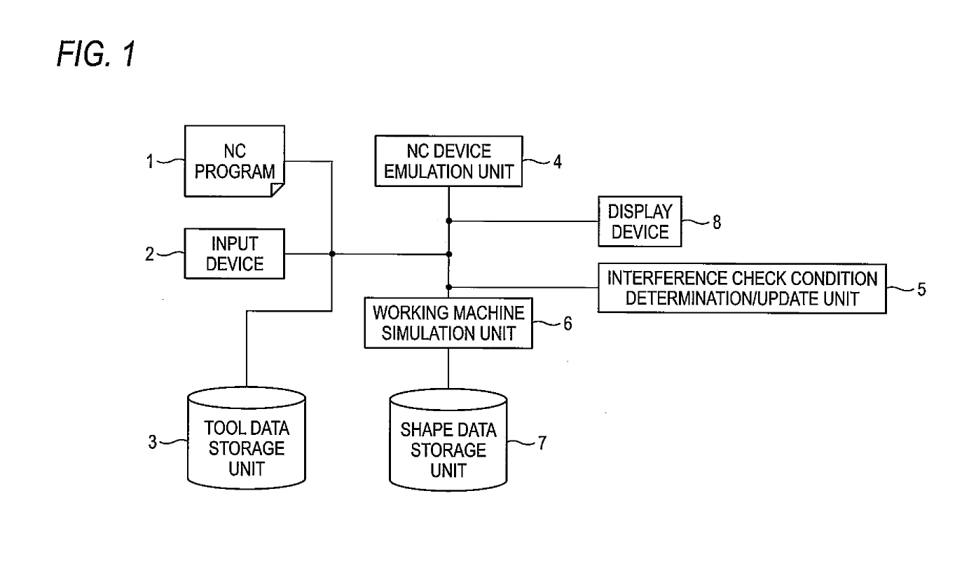

Hereinafter, a first embodiment of the invention will be described by referring to FIGS. 1 to 7.

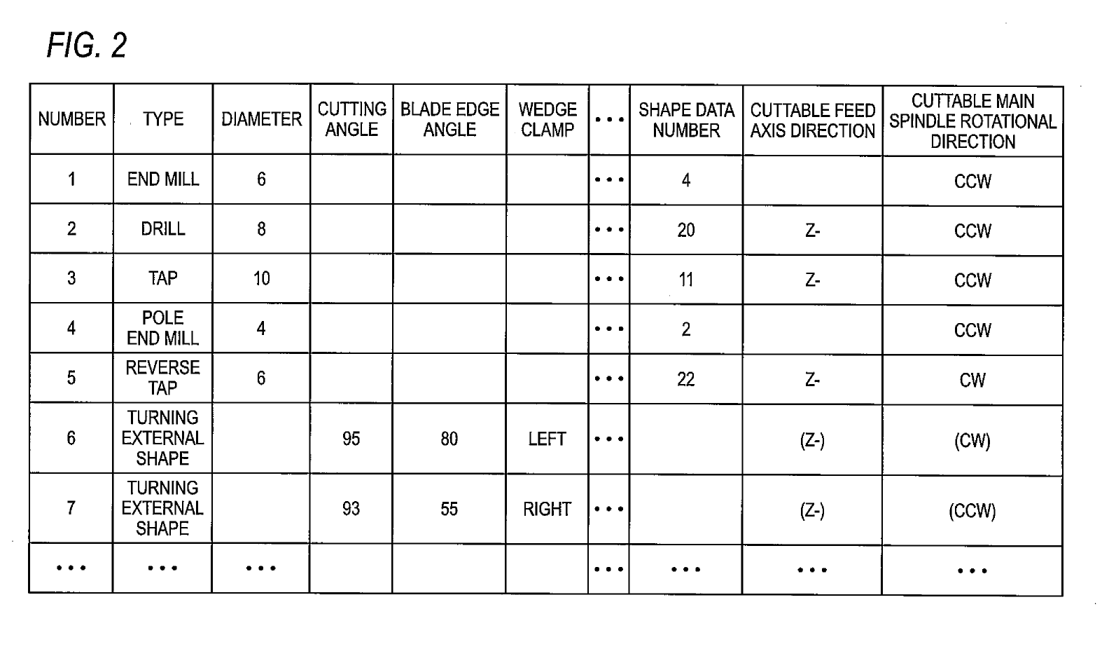

FIG. 1 is a block diagram illustrating a simulation device for an NC working machine mounted on a computer such as a personal computer according to the first embodiment of the invention. The reference numeral 1 denotes an NC program that stores information on a movement command, a feed speed, a main spindle rotation command, and the like used for performing a desired processing. The reference numeral 2 denotes an input device that is used to perform setting of tool data, an operation of a screen displayed through a display device 8, start/finish of a simulation, setting of a simulation unit 6 of a working machine, a supply of a direct movement command, and the like. The reference numeral 3 denotes a tool data storage unit that stores information (tool data) on the tool shown in FIG. 2 for each tool. The tool data for each tool includes data such as a type of a tool, a diameter of a tool, a cutting angle, a blade edge angle, a wedge clamp, a data number related to shape data, a cuttable feed axis direction (a cuttable feed axis direction of a tool), and a cuttable main spindle rotational direction.

The reference numeral 4 denotes an NC machine emulation unit that reads the NC program 1, and supplies various commands such as a movement command, a tool exchange command, or a main spindle rotation command, a currently attached tool number, or a current state such as a current rotational direction of the main spindle to the working machine simulation unit 6 and an interference check condition determination/update unit 5. The reference numeral 5 denotes an interference check condition determination/update unit that receives various commands and various current states supplied from the NC machine emulation unit 4, reads tool data corresponding to a current tool attached to the inside of the simulation device from the tool data storage unit 3, compares the cuttable main spindle rotational direction and the cuttable feed axis direction included in the read tool data with various movement commands (the feed axis direction command) and the main spindle rotational direction supplied from the NC machine emulation unit 4, and then decides whether the interference check between the workpiece and the tool blade edge is enabled or disabled. The reference numeral 6 denotes a working machine simulation unit that simulates a cutting shape of a workpiece or an operation of an NC working machine by changing or moving shape data of a workpiece, a tool, a jig, a machine, and the like by using shape data of the shape data storage unit 7 and various commands supplied from the NC machine emulation unit 4. The reference numeral 7 denotes a shape data storage unit that stores shape data of a workpiece, a tool, a jig, a machine, and the like. The reference numeral 8 denotes a display device that displays data related to NC such as a coordinate value during execution, a program line during execution, and a model, an operation of a machine executed by the working machine simulation unit 6, or a cutting shape of a workpiece.

Further, the NC machine emulation unit 4, the interference check condition determination/update unit 5, and the working machine simulation unit 6 are realized by software.

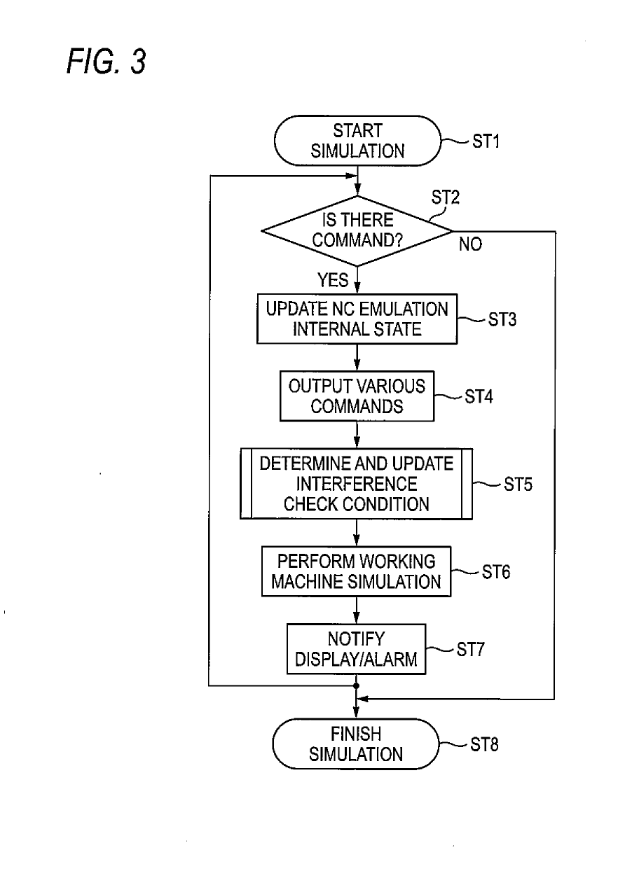

Next, the operation of the simulation device for the NC working machine having the configuration of FIG. 1 will be described by referring to FIG. 3.

First, before the simulation starts, shape data of a workpiece, a tool, a jig, a machine, and the like of a simulation target is input from the input device 2, the shape data is stored in the shape data storage unit 7, and the NC program 1 is also stored in the computer.

Further, as shown in FIG. 2, when there is a limitation related to the cuttable main spindle rotational direction or the cuttable feed axis direction, the shaft name such as “Z−”, “Z+”, and “Z stop” as the cuttable feed axis direction, the shaft number, and the direction are set with respect to the tool data in the tool data storage unit 3 from the input device 2. Then, a predetermined rule is set in the cuttable main spindle rotational direction. For example, in the case of the turning main spindle, the clockwise direction is set as “CW” when the turning main spindle is seen from the chuck end surface, the counter-clockwise direction is set as “CCW”, and the stop state is set as “stop”. In the case of a rotation tool, “CW”, “CCW”, and “stop” are set when the tool shaft is seen from its front end to its base end. Where there is no limitation in theses, the box without limitation is left empty.

Further, here, the Z direction indicates the direction equal to the axial direction of the rotating workpiece during a turning process.

Further, in the turning bite tool (Nos. 6 and 7 of FIG. 2), there is a tool having a shape in which the cuttable feed axis direction is substantially specified, and the difference in shape is called a “wedge clamp”. The wedge clamp is distinguished as below. When the side having the cutting surface is seen so that the tool blade is located at the lower position and the shank is located at the upper position, the right wedge clamp has a main cutting blade located at the right side, and the left wedge clamp has a main cutting blade located at the left side. In the case of the turning bite, as shown in FIG. 2, the wedge clamp is set in the tool data storage unit 3, but the cuttable feed axis direction and the cuttable main spindle rotational direction may not be set in the tool data storage unit 3. In this case, the cuttable feed axis direction and the cuttable main spindle rotational direction are decided on the basis of information on the wedge clamp. For example, when the cuttable feed axis direction and the cuttable main spindle rotational direction of the tool data are not set in the tool data of the current turning bite, and the right wedge clamp is set as the wedge clamp data, the cuttable feed axis direction is set as “Z−” and the cuttable main spindle rotational direction is set as “CCW”. Then, when the left wedge clamp is set, the cuttable feed axis direction is set as “Z−” and the cuttable main spindle rotational direction is set as “CW”.

Further, in FIG. 2, as for data “Z−, CW, and CCW” in parentheses input to the box of the cuttable feed axis direction and the box of the cuttable main spindle rotational direction, the cuttable feed axis direction and the cuttable main spindle rotational direction were not set at the first time, but the wedge clamp was set (is set), the data is set on the basis of the wedge clamp.

When the simulation is started (ST1), the NC machine emulation unit 4 reads out the NC program 4 when simulating an automatic operation using the NC program 1, and reads out a command when there is a direct command from the input device 2.

When there is a command (ST2), the internal state such as a current tool number, a current position, a feed speed, a main spindle rotation speed, a main spindle rotational direction, and a control mode is updated (ST3), and various commands such as a movement command, a tool exchange command, and a main spindle rotation command, a currently attached tool number, and a current state such as a current main spindle rotational direction are output to the working machine simulation unit 6 and the interference check condition determination/update unit 5 (ST4).

When there is no command in ST2, the simulation is finished (ST8).

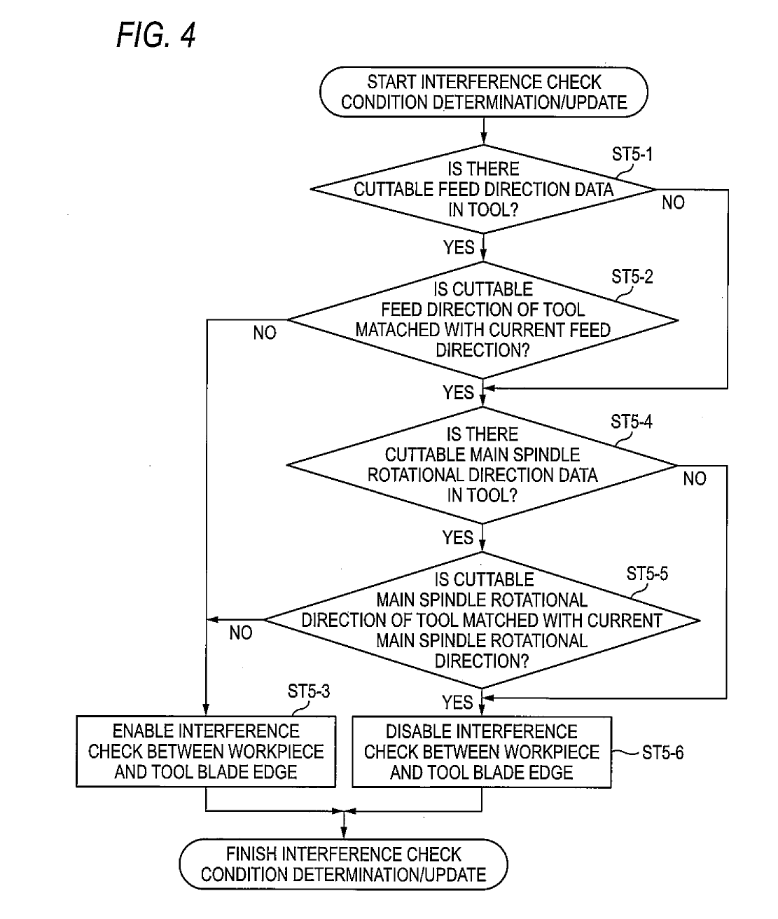

The interference check condition determination/update unit 5 compares the cuttable feed axis direction of the currently attached tool with the feed axis direction of the current movement command by using the process procedure to be described later (refer to FIG. 4), compares the cuttable main spindle rotational direction with the current main spindle rotational direction, and decides whether the interference check between the workpiece and the tool blade edge is enabled (the interference check between the workpiece and the tool blade edge is set to be performed) or disabled (the interference check between the workpiece and the tool blade edge is set not to be performed) (ST5).

Further, since the portions other than the tool blade edge in the respective portions of the tool are not originally designed to cut the workpiece, the portions are set as the interference check target at all times.

Further, the interference check disclosed in, for example, JP-A-2008-27045 may be set as the interference check target.

The working machine simulation unit 6 simulates various movements of the working machine, for example, a shape in which the workpiece is cut by the tool, a tool exchange movement of the working machine, or a movement shape of the respective portions of the working machine in accordance with the movement of the respective axes by using the movement command supplied from the NC machine emulation unit 4 and the shape data read from the shape data storage unit 7, and performs the interference check in accordance with the interference check condition decided by the interference check condition determination/update unit 5 (ST6).

Further, since there are known many techniques as a detailed method of the interference check, any one of them may be used. Further, the “interference” may be freely defined, for example, when the respective portions inside the working machine are within a predetermined distance or less or may be defined as a near-miss. The interference check method (the interference detection algorithm) or the interference determination range does not give any influence on the characteristics of the invention.

When the interference is detected by the working machine simulation unit 6, for example, the simulation is temporarily stopped, and the display device 8 performs a notification process in which the interference portion is highlighted or alarm contents are displayed as a character string (ST7).

Here, the detailed process procedure of the interference check condition determination/update unit 5 will be described by referring to FIG. 4.

First, the tool data is read from the tool data storage unit 3, the tool data corresponding to the number of the currently attached tool supplied from the NC machine emulation unit 4 is specified, and it is checked whether the tool has data of the cuttable feed axis direction (ST5-1).

When the result of ST5-1 is yes, it is checked whether the cuttable feed axis direction of the tool is matched with the current feed axis direction supplied from the NC machine emulation unit 4 (ST5-2).

When the result of ST5-1 is no, the process moves to ST5-4 to be described later.

When the result of ST5-2 is yes, the tool data is read from the tool data storage unit 3, the tool data corresponding to the number of the currently attached tool supplied from the NC machine emulation unit 4 is specified, and it is checked whether the tool has the cuttable main spindle rotational direction (ST5-4).

When the result of ST5-2 is no, the interference check between the workpiece and the tool blade edge is enabled (ST5-3), and the process is finished.

When the result of ST5-4 is yes, it is checked whether the cuttable main spindle rotational direction of the tool is matched with the current main spindle rotational direction supplied from the NC machine emulation unit 4 (ST5-5).

When the result of ST5-4 is no, the interference check between the workpiece and the tool blade edge is disabled (ST5-6), and the process is finished.

When the result of ST5-5 is yes, the process moves to ST5-6, the interference check between the workpiece and the tool blade edge is disabled, and the process is finished.

When the result of ST5-5 is no, the process moves to ST5-3, the interference check between the workpiece and the tool blade edge is enabled, and the process is finished.

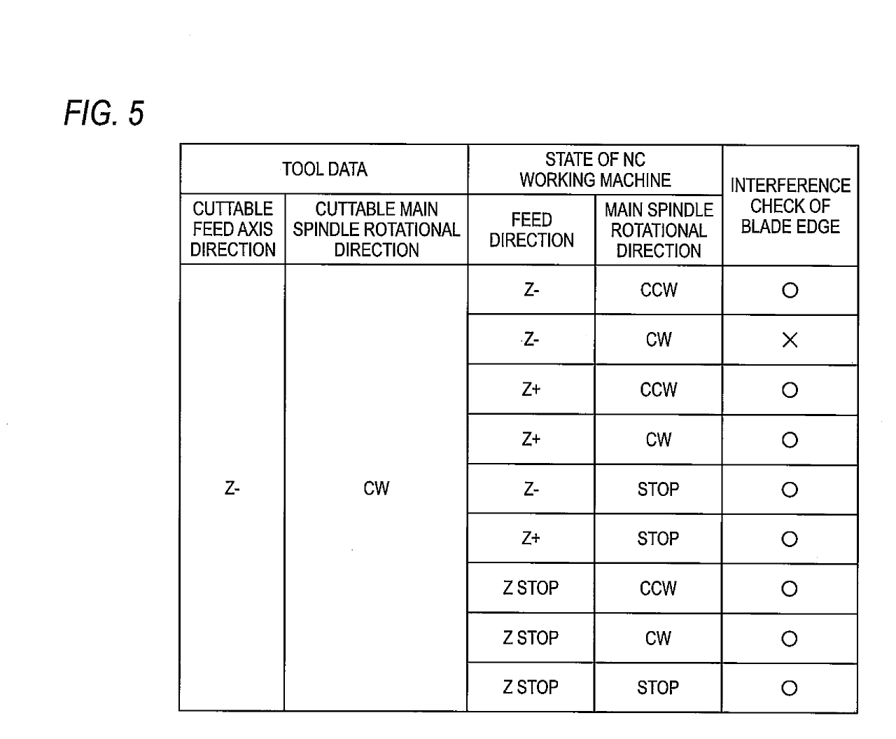

According to this procedure, for example, when the tool corresponding to the “tool data” of FIG. 5 is attached, the enabled/disabled state of the interference check between the tool blade edge and the workpiece in accordance with the state of the NC working machine is set in the box of “interference check of blade edge” of FIG. 5.

Here, when O is recorded in the box of “interference check of blade edge” of FIG. 5, the interference check between the tool blade edge and the workpiece is performed. When X is recorded in the box, the interference check between the tool blade edge and the workpiece is not performed.

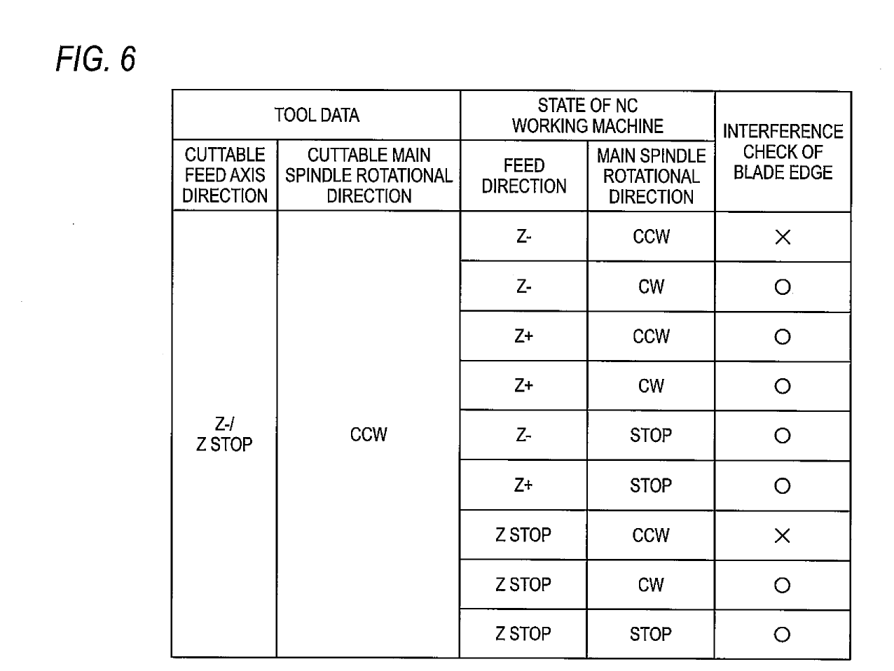

Further, as the tool data, for example, as shown in the column of “tool data” of FIG. 6, plural directions (Z−/Z stop) may be set as the cuttable feed axis direction of the tool data, or plural directions may be set as the cuttable main spindle rotational direction. Even in this case, whether the interference check between the tool blade edge and the workpiece in accordance with the state of the NC working machine is enabled or disabled is set in the box of “interference check of blade edge” of FIG. 6.

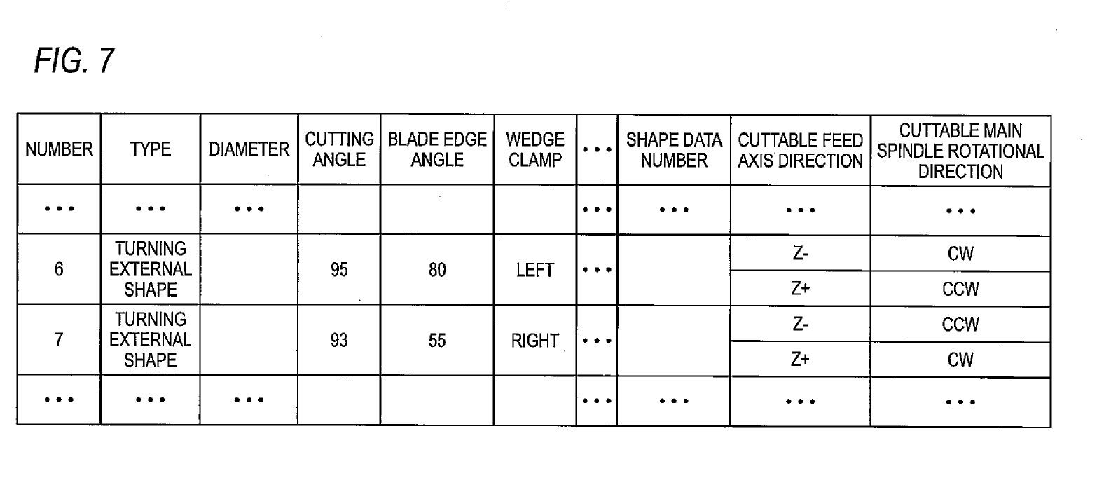

Further, as the tool data, plural pairs each including the cuttable feed axis direction and the cuttable main spindle rotational direction may be set as shown in FIG. 7.

Further, according to the first embodiment, the tool data storage unit 3 stores the cuttable feed axis direction and the cuttable main spindle rotational direction, but may store the uncuttable feed axis direction and the uncuttable main spindle rotational direction.

In this case, the interference check condition determination/update unit 5 enables the interference check when the uncuttable feed axis direction is matched with the current feed axis direction, and disables the interference check when they are not matched with each other. Further, the interference check is enabled when the uncuttable main spindle rotational direction is matched with the current main spindle rotational direction, and the interference check is disabled when they are not matched with each other.

As described above, according to the first embodiment, each tool has the cuttable feed axis direction (or the uncuttable feed axis direction) and the cuttable main spindle rotational direction (or the uncuttable main spindle rotational direction), and they are compared with the feed axis direction and the main spindle rotational direction of the imaginary NC working machine during the execution of the simulation so as to determine whether the cutting may be performed. When it is determined that the cutting may not be performed, the interference check between the workpiece and the tool is performed. Therefore, the number of paths not including the interference check between the workpiece and the tool is reduced, thereby more reliably detecting an abnormal state compared to the method of the background art.

Further, in the first embodiment, the simulation device for the NC working machine that is mounted on the computer to simulate the movement of NC has been described, but a configuration may be adopted in which the simulation device is mounted on the NC machine mounted on the NC working machine and the NC machine controlling the actual working machine is replaced with the NC machine emulation unit 4.

Further, the simulation device may be mounted on the NC machine having a function of preventing a collision between the respective portions present inside a movable range of the working machine in advance by checking interference during the operation of the actual machine. For example, the “collision detection unit” of the “Numerical Control” system disclosed in JP-A-2008-129994 may be replaced with the interference check condition determination/update unit 5 and the working machine simulation unit 6, and the NC, machine controlling the actual working machine may be replaced with the NC machine emulation unit 4. Such difference in configuration does not give any influence on the characteristics of the invention.

### Second Embodiment

The basic operation of a second embodiment is the same as that of the first embodiment. However, the interference check condition determination/update process ST5 in FIG. 3 showing the simulation operation of the NC working machine of the first embodiment is different, and the cuttable feed axis direction and the cuttable main spindle rotational direction are given as a vector to the tool shape data stored in the shape data storage unit 7 so as to determine the inference check.

Hereinafter, only the process different from the first embodiment will be described.

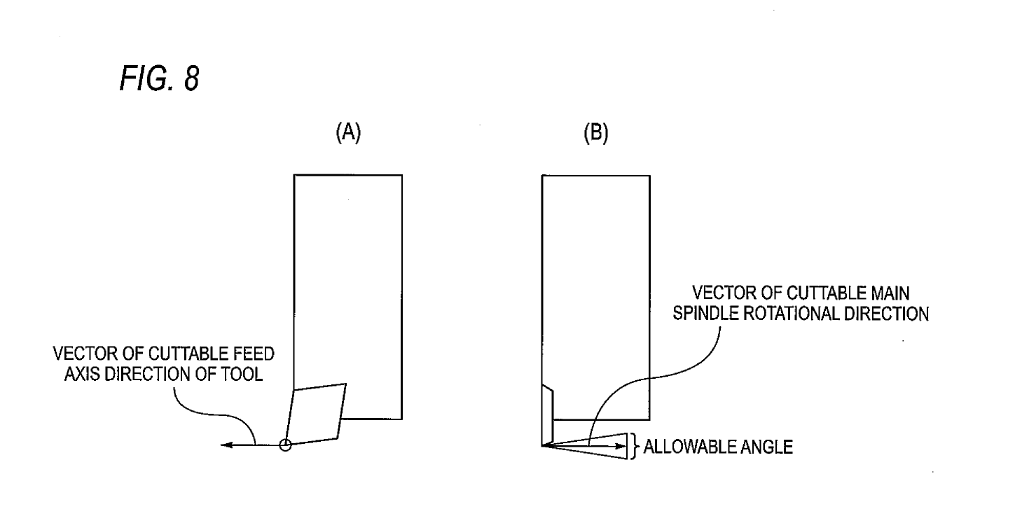

FIG. 8 is a diagram illustrating an example of the tool shape data of the second embodiment, where in FIG. 8(A), the same turning bite is seen so that the cutting surface is located at the upper position, and in FIG. 8(B), the same turning bite is seen by rotating the turning bite of FIG. 8(A) by 90 degree of angle to the left side of the drawing.

In the tool shape data of the second embodiment, the cuttable feed axis direction shown in FIG. 8(A) and the cuttable main spindle rotational direction shown in FIG. 8(B) are expressed as vectors. Further, an allowable angle is given to the vector in the cuttable main spindle rotational direction.

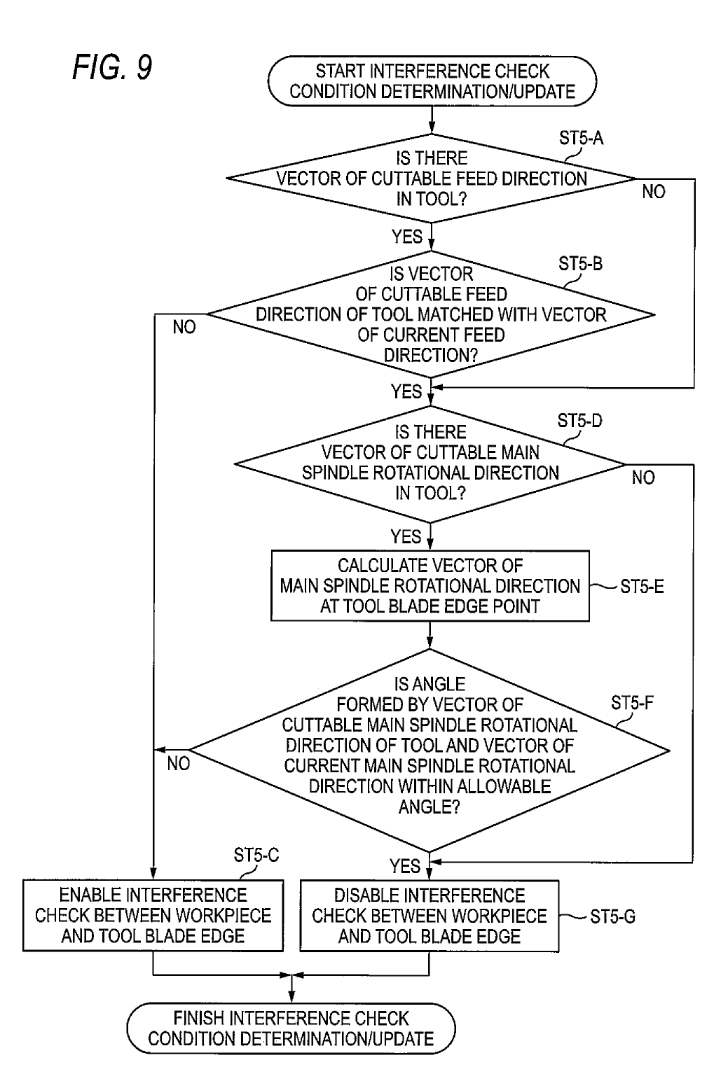

A process will be described which determines whether the interference check between the workpiece and the tool blade edge is performed using the tool shape data. FIG. 9 is a flowchart illustrating a process procedure of another embodiment of the interference check condition determination/update process.

First, the tool data is read from the tool data storage unit 3, the tool data corresponding to the number of the currently attached tool supplied from the NC machine emulation unit 4 is specified, the shape data is read from the shape data storage unit 7, the tool shape data is specified, and it is checked whether the vector of the cuttable feed axis direction is present (ST5-A).

When the result of ST5-A is yes, it is checked whether the vector of the cuttable feed axis direction of the tool is matched with the vector of the current feed axis direction supplied from the NC machine emulation unit 4 (ST5-B).

When the result of ST5-A is no, the process moves to ST5-D to be described later.

When the result of ST5-B is yes, the shape data is read from the shape data storage unit 7, and it is checked whether the vector of the cuttable main spindle rotational direction of the tool is present (ST5-D).

When the result of ST5-B is no, the interference check between the workpiece and the tool blade edge is enabled (ST5-C), and the process is finished.

When the result of ST5-D is yes, in a circle having a radius from the main spindle rotation center to the tool blade edge point, the tangential vector of the current main spindle rotational direction supplied from the NC machine emulation unit 4 is obtained at the tool blade edge point, and the vector is set as the vector of the current main spindle rotational direction (ST5-E). In the next ST5-F, it is checked whether an angle formed between the vector of the cuttable main spindle rotational direction of the tool and the vector of the cuttable main spindle rotational direction of the tool is within the allowable angle of the vector of the main spindle rotational direction obtained in ST5-E (ST5-F).

When the result of ST5-D is no; the interference check between the workpiece and the tool blade edge is disabled (ST5-G), and the process is finished.

When the result of ST5-F is yes, the process moves to ST5-G the interference check between the workpiece and the tool blade edge is disabled, and the process is finished.

When the result of ST5-F is no, the process moves to ST5-C, the inference check between the workpiece and the tool blade edge is enabled, and the process is finished.

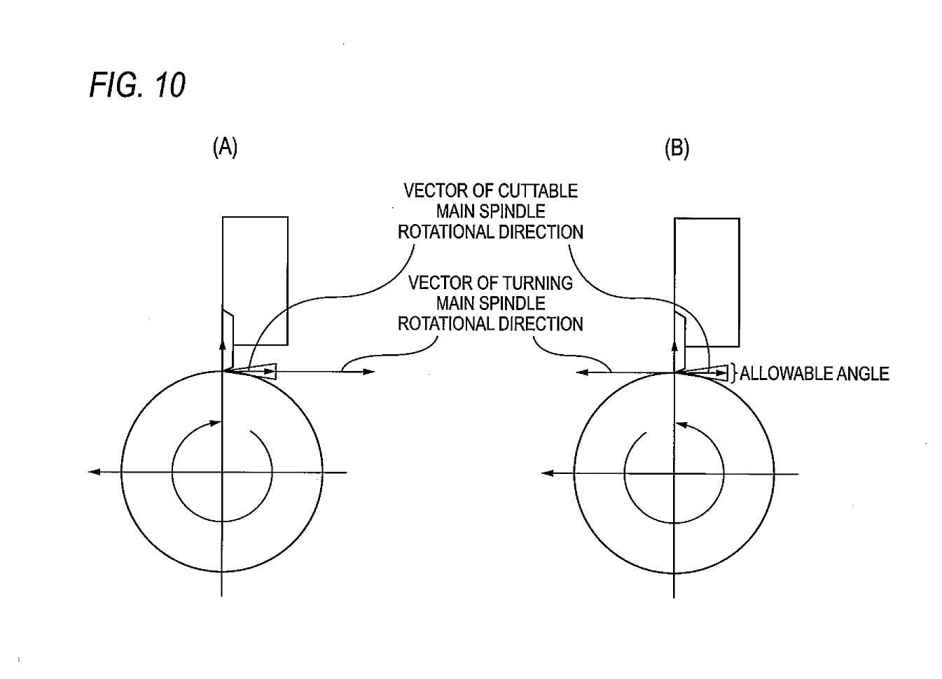

According to this procedure, for example, when the angle formed between the vector of the turning main spindle rotational direction of the NC working machine and the vector of the cuttable main spindle rotational direction is within an allowable angle as shown in FIG. 10(A) while the tool shown in FIGS. 8(A) and 8(B) is attached and the cuttable feed axis direction of the tool is matched with the current feed axis direction of the NC working machine at a certain time point during the execution of the simulation, since the correct cutting may be performed, the interference check between the workpiece and the tool blade edge is disabled. On the contrary when the angle formed between the vector of the turning main spindle rotational direction of the NC working machine and the vector of the cuttable main spindle rotational direction of the tool is out of the allowable angle as shown in FIG. 10(B), since the correct cutting may not be performed, the interference check between the workpiece and the tool blade edge is enabled.

Further, in the second embodiment, the shape data storage unit 7 stores the vector of the cuttable feed axis direction and the vector of the cuttable main spindle rotational direction, but may store the vector of the uncuttable feed axis direction and the vector of the uncuttable main spindle rotational direction.

In this case, the interference check condition determination/update unit 5 enables the interference check when the vector of the uncuttable feed axis direction is matched with the vector of the current feed axis direction, and disables the interference check when they are not matched with each other. Further, the interference check is enabled when the vector of the uncuttable main spindle rotational direction is matched with the vector of the current main spindle rotational direction, and the interference check is disabled when they are not matched with each other.

As described above, according to the second embodiment, the following advantages are obtained.

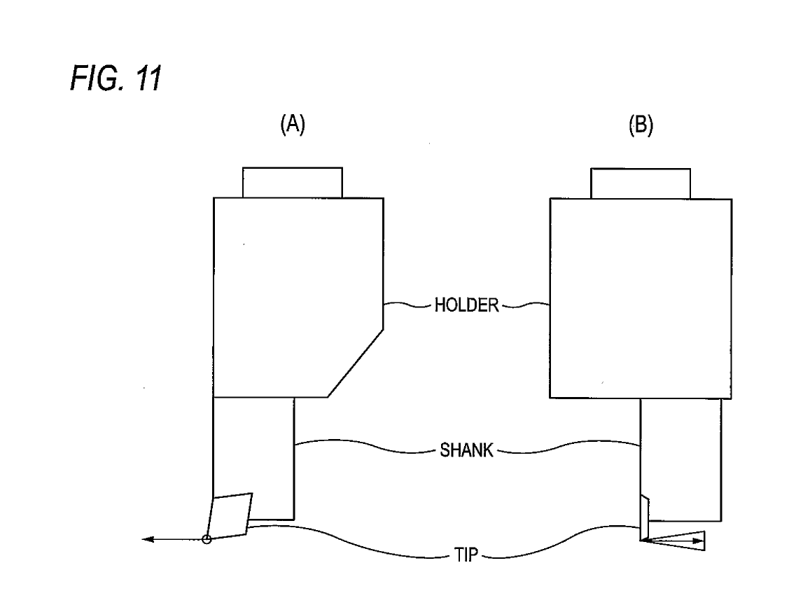

In general, each tool includes plural components. For example, FIG. 11 illustrates a turning tool that is attached to a mill main spindle frequently used in a multi-functional machine, and the turning tool includes a holder, a shank, and a tip (blade edge). In the case of the tool, the final cutting surface of the tool is decided in accordance with the rotation angle of the mill main spindle, the corresponding wedge clamp of the holder, and the wedge clamp of the shank. Further, in FIG. 11(A), the cutting surface is seen from the upside thereof. In FIG. 11(B), the cutting surface is seen by rotating the cutting surface of FIG. 11(A) by 90 degree of angle to the left side of the drawing.

When the simulation is performed by using the tool, the three components are defined as a modeling language, CAD data, or the like, and they are combined in a three-dimensional space to thereby form one tool. When the cuttable main spindle rotational direction and the cuttable feed axis direction are set as the fixed vectors with respect to the shape data of the shank, the final cuttable direction is decided even when the tool is assembled in the holder. For this reason, an operator does not need to manually input such information into the tool data.

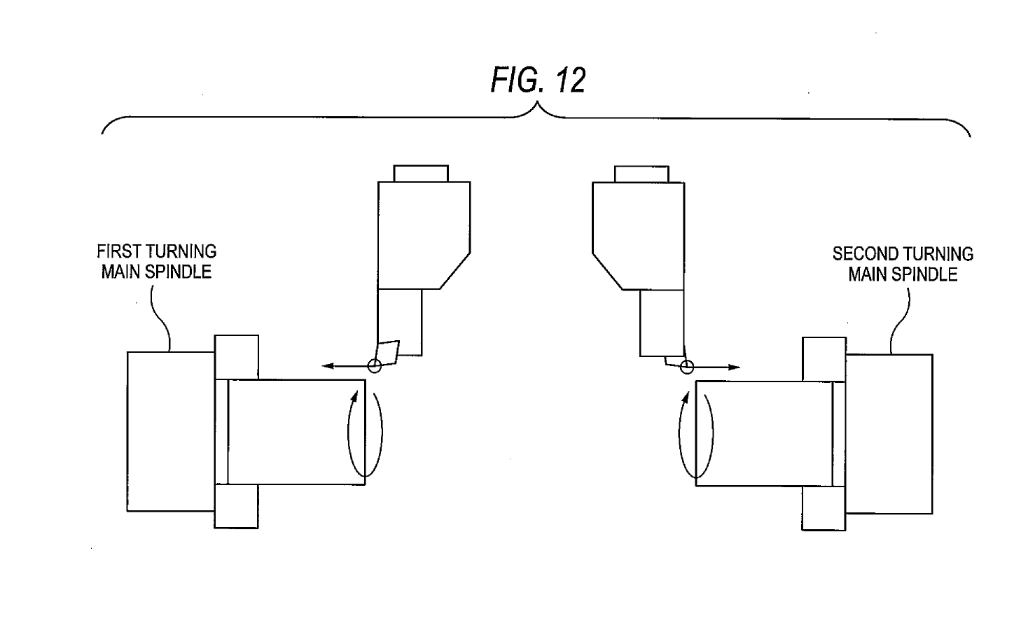

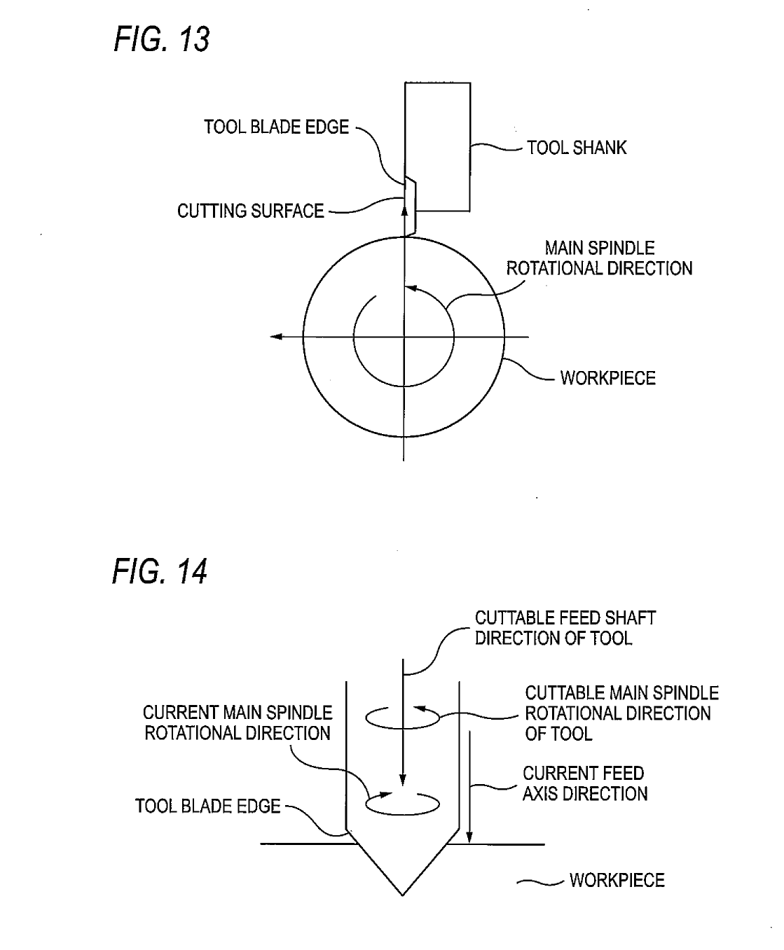

Further, as shown in FIG. 12, when the tool is rotated by 180 degree of angle about the shaft of the tool so as to process the workpiece located at the second turning main spindle opposite to the first turning main spindle, the vector of the cuttable main spindle rotational direction and the vector of the cuttable feed axis direction given to the shape change in accordance with the rotation of the tool. Accordingly, the cuttable main spindle rotational direction and the cuttable feed axis direction of the tool indicate the correct directions at all times, and the correct determination may be performed.

Further, each tool has the vectors of the cuttable feed axis direction and the cuttable main spindle rotational direction, the feed axis direction and the main spindle rotational direction of the imaginary NC working machine during the execution of the simulation have an allowable angle, and it is determined whether the cutting may be performed, thereby more accurately determining the interference check condition.

### INDUSTRIAL APPLICABILITY

The method and the device for simulating the NC working machine according to the invention is suitable for checking the interference between the tool blade edge and the workpiece in advance when the workpiece is processed by controlling the working machine through NC.

1. A method for simulating an NC working machine so that a processing shape of a workpiece or a movement of a machine is simulated by using a shape of the tool or the workpiece, the method comprising the steps of:
deciding a cuttable main spindle rotational direction or an uncuttable main spindle rotational direction for each tool in advance before execution of a simulation;
comparing the cuttable main spindle rotational direction or the uncuttable main spindle rotational direction of the selected tool with each main spindle rotational direction of a working machine during the execution of the simulation so as to determine whether an interference check between the tool and the workpiece is necessary on the basis of the comparison result; and
disabling the interference check between the tool and the workpiece when it is determined that the interference check is not necessary in the step above, enabling the interference check between the tool and the workpiece when it is determined that the interference check is necessary, and detecting abnormality when the interference between the tool and the workpiece is present.

2. A method for simulating an NC working machine so that a processing shape of a workpiece or a movement of a machine is simulated by using a shape of the tool or the workpiece, the method comprising the steps of:
deciding a cuttable main spindle rotational direction and a cuttable feed axis direction or an uncuttable main spindle rotational direction and an uncuttable feed axis direction for each tool in advance before execution of a simulation;
comparing the cuttable main spindle rotational direction or the uncuttable main spindle rotational direction of the selected tool with each main spindle rotational direction of a working machine during the execution of the simulation so as to determine whether an interference check between the tool and the workpiece is necessary;
comparing the cuttable feed axis direction or the uncuttable feed axis direction of the selected tool with each feed axis direction of the working machine during the execution of the simulation so as to determine whether an interference check between the tool and the workpiece is necessary on the basis of the comparison result; and
disabling the interference check between the tool and the workpiece when it is determined that the interference check is not necessary in the steps above, enabling the interference check between the tool and the workpiece when it is determined that the interference check is necessary, and detecting abnormality when the interference between the tool and the workpiece is present.

3. The method according to claim 2,
wherein
the cuttable main spindle rotational direction and the cuttable feed axis direction or the uncuttable main spindle rotational direction and the uncuttable feed axis direction are decided on the basis of wedge clamp data of the tool set in advance in tool data.

4. The method according to claim 1,
wherein
the cuttable main spindle rotational direction or the uncuttable main spindle rotational direction is expressed as a vector of the cuttable main spindle rotational direction or a vector of the uncuttable main spindle rotational direction given to tool shape data related to data of each tool stored in the tool data.

5. The method according to claim 2,
wherein
the cuttable main spindle rotational direction and the cuttable feed axis direction or the uncuttable main spindle rotational direction and the uncuttable feed axis direction are expressed as a vector of the cuttable main spindle rotational direction and a vector of the cuttable feed axis direction or a vector of the uncuttable main spindle rotational direction and a vector of the uncuttable feed axis direction given to tool shape data related to data of each tool stored in the tool data.

6. The method according to claim 2,
wherein
the cuttable main spindle rotational direction and the cuttable feed axis direction or the uncuttable main spindle rotational direction and the uncuttable feed axis direction of the tool data are expressed as vectors given to tool shape data, and in the case of a tool allowing a deviation between the vectors within a certain range, an allowable angle is given to the vectors.

7. A device for simulating an NC working machine so that a processing shape of a workpiece or a movement of a machine is simulated by using a shape of the tool or the workpiece, the device comprising:
a storage unit which stores a cuttable main spindle rotational direction or an uncuttable main spindle rotational direction for each tool;
an interference check condition determination/update unit which compares the cuttable main spindle rotational direction or the uncuttable main spindle rotational direction of the selected tool with each main spindle rotational direction of a working machine during the execution of the simulation so as to determine whether an interference check between the tool and the workpiece is necessary on the basis of the comparison result; and
a working machine simulation unit which disables the interference check between the tool and the workpiece when the interference check condition determination/update unit determines that the interference check is not necessary, enables the interference check between the tool and the workpiece when the interference check condition determination/update unit determines that the interference check is necessary, and detects abnormality when the interference between the tool and the workpiece is present.

8. A device for simulating an NC working machine so that a processing shape of a workpiece or a movement of a machine is simulated by using a shape of the tool or the workpiece, the device comprising:
a storage unit which stores a cuttable main spindle rotational direction and a cuttable feed axis direction or an uncuttable main spindle rotational direction and an uncuttable feed axis direction for each tool;
an interference check condition determination/update unit which compares the cuttable main spindle rotational direction or the uncuttable main spindle rotational direction of the selected tool with each main spindle rotational direction of the working machine, and compares the cuttable feed axis direction or the uncuttable feed axis direction of the selected tool with each feed axis direction of the working machine during the execution of the simulation so as to determine whether an interference check between the tool and the workpiece is necessary on the basis of the comparison results; and
a working machine simulation unit which disables the interference check between the tool and the workpiece when the interference check condition determination/update unit determines that the interference check is not necessary, enables the interference check between the tool and the workpiece when the interference check condition determination/update unit determines that the interference check is necessary, and detects abnormality when the interference between the tool and the workpiece is present.

9. A device for simulating an NC working machine so that a processing shape of a workpiece or a movement of a machine is simulated by using a shape of the tool or the workpiece, the device comprising:
a storage unit which stores wedge clamp data of the tool for each tool;
an interference check condition determination/update unit which decides a cuttable main spindle rotational direction or an uncuttable main spindle rotational direction and a cuttable feed axis direction or an uncuttable feed axis direction on the basis of the wedge clamp data of the tool, compares the cuttable main spindle rotational direction or the uncuttable main spindle rotational direction of the selected tool with each main spindle rotational direction of the working machine, and compares the cuttable feed axis direction or the uncuttable feed axis direction of the selected tool with each feed axis direction of the working machine during the execution of the simulation so as to determine whether an interference check between the tool and the workpiece is necessary on the basis of the comparison results; and
a working machine simulation unit which disables the interference check between the tool and the workpiece when the interference check condition determination/update unit determines that the interference check is not necessary, enables the interference check between the tool and the workpiece when the interference check condition determination/update unit determines that the interference check is necessary, and detects abnormality when the interference between the tool and the workpiece is present.

10. The device according to claim 7,
wherein
the cuttable main spindle rotational direction or the uncuttable main spindle rotational direction is expressed as a vector of the cuttable main spindle rotational direction or a vector of the uncuttable main spindle rotational direction given to tool shape data related to data of each tool stored in the tool data.

11. The device according to claim 8,
wherein
the cuttable main spindle rotational direction and the cuttable feed axis direction or the uncuttable main spindle rotational direction and the uncuttable feed axis direction are expressed as a vector of the cuttable main spindle rotational direction and a vector of the cuttable feed axis direction or a vector of the uncuttable main spindle rotational direction and a vector of the uncuttable feed axis direction given to tool shape data related to data of each tool stored in the tool data.

12. The device according to claim 8,
wherein
the cuttable main spindle rotational direction and the cuttable feed axis direction or the uncuttable main spindle rotational direction and the uncuttable feed axis direction of the tool data are expressed as vectors given to tool shape data, and in the case of a tool allowing a deviation between the vectors within a certain range, an allowable angle is given to the vectors.

13. The method according to claim 3,
wherein
the cuttable main spindle rotational direction and the cuttable feed axis direction or the uncuttable main spindle rotational direction and the uncuttable feed axis direction are expressed as a vector of the cuttable main spindle rotational direction and a vector of the cuttable feed axis direction or a vector of the uncuttable main spindle rotational direction and a vector of the uncuttable feed axis direction given to tool shape data related to data of each tool stored in the tool data.

14. The method according to claim 3,
wherein
the cuttable main spindle rotational direction and the cuttable feed axis direction or the uncuttable main spindle rotational direction and the uncuttable feed axis direction of the tool data are expressed as vectors given to tool shape data, and in the case of a tool allowing a deviation between the vectors within a certain range, an allowable angle is given to the vectors.

15. The device according to claim 9,
wherein
the cuttable main spindle rotational direction and the cuttable feed axis direction or the uncuttable main spindle rotational direction and the uncuttable feed axis direction are expressed as a vector of the cuttable main spindle rotational direction and a vector of the cuttable feed axis direction or a vector of the uncuttable main spindle rotational direction and a vector of the uncuttable feed axis direction given to tool shape data related to data of each tool stored in the tool data.

16. The device according to claim 9,
wherein
the cuttable main spindle rotational direction and the cuttable feed axis direction or the uncuttable main spindle rotational direction and the uncuttable feed axis direction of the tool data are expressed as vectors given to tool shape data, and in the case of a tool allowing a deviation between the vectors within a certain range, an allowable angle is given to the vectors.
